(19) United States
(12) Patent Application Publication
(10) Pub. No.: US 2023/0024193 A1
(43) Pub. Date: Jan. 26, 2023

(54) TRANSISTOR-TYPE SENSOR

(71) Applicants: The University of Tokyo, Tokyo (JP); JNC CORPORATION, Tokyo (JP)

(72) Inventors: Tsuyoshi MINAMI, Tokyo (JP); Katsumasa NAKAHARA, Chiba (JP); Toshihiro KOIKE, Chiba (JP)

(73) Assignees: The University of Tokyo, Tokyo (JP); JNC CORPORATION, Tokyo (JP)

(21) Appl. No.: 17/787,582

(22) PCT Filed: Feb. 19, 2021
(86) PCT No.: PCT/JP2021/006343

§ 371 Date: Jun. 20, 2022

(30) Foreign Application Priority Data
Feb. 26, 2020 (JP) 2020-030081

(51) Int. Cl. G01N 27/414; B82Y 10/00; B82Y 15/00

(52) U.S. Cl. CPC G01N 27/4145; B82Y 10/00; B82Y 15/00

(57) ABSTRACT

A transistor-type sensor capable of detecting a compound having an amino group has a simple structure and also is expected to be effective in antioxidation action and prevention of dementia, etc. The transistor-type sensor includes a detection electrode for capturing a compound having an amino group for detection, and a transistor having a gate electrode connected with the detection electrode. The detection electrode has a cucurbituril structure-containing compound immobilized on the surface thereof.

### FIELD OF THE INVENTION

This invention relates to a transistor-type sensor for detecting a chemical substance, specifically a compound having an amino group.

### DESCRIPTION OF RELATED ART

In recent years, with the health consciousness of daily life, there has been an increasing demand for easy monitoring of chemical substances, In order to analyze nutrients contained in foods and environmentally hazardous substances, large and expensive analytical machines such as mass spectrometer and expensive analytical reagents have been required so far, However, in the future, a quick and simple analysis method will be required, which is expected to make the human life more comfortable.

In such background, research and development is progressing on a method in which a self-assembled monolayer (SAM) is formed on an inorganic substance such as a metal to serve as a receptor to interact with the to-be-detected target substance and an external signal such as electricity or light is extracted. Known interactions utilized are chemical reactions of covalent bonds or the like, antibody-antigen reactions, and supra.molecular recognition by host-guest.

As an example reported so far, a signal is extracted by specifically binding a receptor to a specific chemical substance, but this method requires producing a wide variety of receptors for corresponding to a wide variety of compounds and is therefore considered to be industrially unrealistic. On the other hand, the method which produces only a small number of receptors having a certain margin of reaction site and responding to a wide variety of chemical substances but having different response strengths thereto is higher in the speed of development and is also industrially ideal.

Under such demand, it is known that cucurbit[n]uril has a capturing ability for various compounds due to the presence of voids exhibiting hydrophilicity and hydrophobicity (Patent Literatures 1 and 2 and Non-Patent Literature 1). Since cucurbit[n]uril has a carbonyl group at the void inlet, it is able to capture various ionic compounds and highly polar compounds by charge-polar interaction, polar-polar interaction or hydrogen bonding, and is thus different from other macrocyclic compounds. Therefore, cucurbit[n]uril has various capturing abilities for amino acids, nucleic acids, metal ions, organometallic ions and illegal drugs, etc., and further, the capture mode and the captured compounds depend on the size of the ring structure of the cucurbit[n]uril. Hence, cucurbit[n]uril is a very interesting compound.

Known cucurbit[n]uril-using responses are mainly optical response in solution, response to nuclear magnetic resonance, and responses to isothermal titration calorimetry, etc., but these analyzes still require relatively large analytical instruments. For simple analyses in the future, it is desired to support a compound with a supramolecular interaction on an inorganic substance such as a metal to form a chip that can be carried around.

### CITATION LIST

### Patent Literature

Patent Literature 1: Japanese Unexamined Patent Application Publication No. 2007-500763 (JP2007500763A)

Patent Literature 2: Japanese Unexamined Patent Application Publication No. 2007-521487 (JP2007521487A)

### Non-Patent Literature

Non-Patent Literature 1: Chem. Rev. 2015, 115, 12320.

### SUMMARY OF THE INVENTION

### Technical Problem

An object of this invention is to provide a sensor for detecting a compound having an amino group used in various applications.

### Solution to Problem

As a result of diligent research, the inventors have found that a transistor-type sensor having a detection electrode with a cucurbituril structure-containing compound immobilized on its surface can detect imidazole, thus completing this invention.

That is, this invention includes the followings.

[1] is a transistor-type sensor that comprises a detection electrode for capturing a compound having an amino group for detection, and a transistor having a gate electrode connected with the detection electrode, wherein the detection electrode has a cucurbituril structure-containing compound immobilized on a surface thereof

[2] is the transistor-type sensor of [1] in which the compound having an amino group has a molecular weight of 10,000 or less.

[3] is the transistor-type sensor of [1] in which the compound having an amino group is selected from the group consisting of polyamines, amino acids, and peptide bonding-containing compounds.

[4] is the transistor-type sensor of [1] in which the compound having an amino group is an imidazole dipeptide.

[5] is the transistor-type sensor of any one of [1] to [4] in which the threshold voltage or the drain current of the transistor changes on capturing the compound having an amino group.

[6] is the transistor-type sensor of any one of [1] to [5] in which the cucurbituril structure-containing compound interacts with the surface of the detection electrode to form a self-assembled monolayer.

[7] is the transistor-type sensor of any one of [1] to [6] in which the cucurbituril structure-containing compound is a compound represented by formula (1),

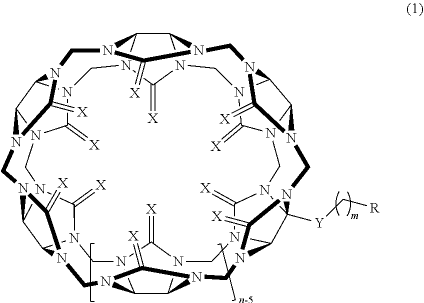

wherein n is an integer from 5 to 20, m is an integer from 1 to 10, X and Y each independently represent a chalcogen atom selected from the group consisting of oxygen, sulfur and selenium, R is selected from the group consisting of SH, COOH, Si(OR₁)₃, PO(OH)₂ and SS-R₂, R₁ represents an alkyl group having 1 to 5 carbon atoms, and R₂ represents an organic group.

### Advantageous Effects of Invention

The transistor-type sensor of this invention has a simple structure, but is able to detect a compound having an amino group used for various purposes.

### BRIEF DESCRIPTION OF DRAWINGS

FIG. 1 is a schematic graph of the transistor type sensor of Example 1.

FIG. 2 is a schematic graph of the immobilization of a cucurbituril structure-containing compound on the electrode surface.

FIG. 3 is a fabricating procedure of the transistor type sensor of Example 1.

FIG. 4 is a diagram showing the variations in transfer characteristics with respect to the carnosine solutions of Example 1.

FIG. 5 is a diagram showing the variation of the threshold voltage shift ratio when the transistor type sensor of Example 1 is used.

FIG. 6 is a diagram comparing the threshold value shift amounts of the case where a CB [6] treated detection electrode was used and the case where the detection electrode was not treated.

FIG. 7 shows 20 kinds of amino acids constituting the proteins used in the Examples.

FIG. 8 shows the variation of the threshold voltage shift ratio with the concentration of aspartic acid, glutamic acid, methionine, arginine or asparagine under a neutral condition.

FIG. 9 shows the variation of the threshold voltage shift ratio with the concentration of threonine, lysine, cysteine, proline or valine under a neutral condition.

FIG. 10 shows the variation of the threshold voltage shift ratio with the concentration of glycine, alanine, histidine, serine or leucine under a neutral condition.

FIG. 11 shows the variation of the threshold voltage shift ratio with the concentration of isoleucine, phenylalanine, tryptophan, glutamine or tyrosine under a neutral condition.

FIG. 12 shows the variation of the threshold voltage shift ratio with the concentration of aspartic acid, glutamic acid, methionine, arginine or asparagine under an acidic condition.

FIG. 13 shows the variation of the threshold voltage shift ratio with the concentration of threonine, lysine, cysteine, proline or valine under an acidic condition.

FIG. 14 shows the variation of the threshold voltage shift ratio with the concentration of glycine, alanine, histidine, serine or leucine under an acidic condition.

FIG. 15 shows the variation of the threshold voltage shift ratio with the concentration of isoleucine, phenylalanine, tryptophan, glutamine or tyrosine under an acidic condition.

FIG. 16 shows the variation of the threshold voltage shift ratio with the concentration of glycine, alanine, proline or glutamine under a neutral condition and under an acidic condition, respectively.

FIG. 17 shows the variation of the threshold voltage shift ratio with the concentration of inosine, guanylic acid or nicotinamide adenine dinucleotide when the sensor of Example 1 was used.

FIG. 18 shows the variation of the threshold voltage shift ratio with the concentration of inosine, guanylic acid or nicotinamide adenine dinucleotide when the sensor of Example 2 was used.

### DESCRIPTION OF EMBODIMENTS

This invention will be specifically described hereinafter. The transistor-type sensor of this invention includes a detection electrode for capturing a compound having an amino group for detection, and a transistor having a gate electrode connected to the detection electrode, wherein the detection electrode has a cucurbituril structure-containing; compound immobilized on the surface thereof.

[Regarding Transistor-Type Sensor]

### (Detection Electrode)

The transistor-type sensor of this invention includes a detection electrode for detecting a compound having an amino group. The detection electrode is an extension gate electrode of the transistor.

The detection electrode has a cucurbituril structure-containing compound immobilized on the surface of its electrode body. In this invention, the cucurbituril structure-containing compound is a compound containing the structure below (referred to as “cucurbituril structure” hereinafter).

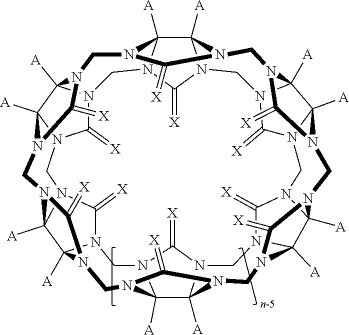

In the above formula, n is an integer from 5 to 20, and X and Y each independently represent a chalcogen atom selected from the group consisting of oxygen, sulfur and selenium. Further, A is a hydrogen atom, or an atom or an organic group substituting a hydrogen atom.

In this invention, the cucurbituril structure-containing compound is not particularly limited as long as it contains a cucurbituril structure, but is preferably a cucurbituril structure-containing compound represented by formula (1) below.

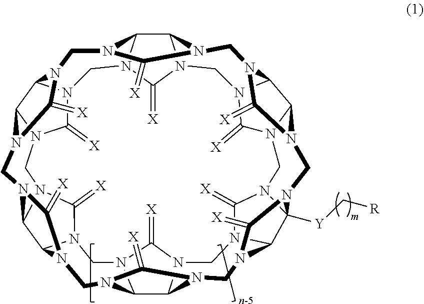

In formula (1), n is an integer from 5 to 20, m is an integer from 1 to 10, X and Y each independently represent a chalcogen atom selected from the group consisting of oxygen, sulfur and selenium, and R represents a substituent selected from the group consisting of SH, COOH, Si(OR₁)₃, PO(OH)₂ and SS-R₂, wherein R₁ represents an alkyl group having 1 to 5 carbon atoms, and R₂ represents an organic group. Hereinafter, a specific description will be given.

The compound represented by the formula (1) is a compound containing a cucurbituril structure (cyclic structure), wherein n represents the number of the glycoluril units constituting the compound and represents an integer from 5 to 20. From the viewpoints of the strength of the interaction with the substance to be detected and the availability, n is preferably an integer from 5 to 12, and more preferably an integer from 5 to 10.

In formula (1), m represents the number of the methylene group units, and represents an integer from 1 to 20. When m is large, the length of the methylene spacer becomes long. From the viewpoints of the strength of the interaction with the substance to be detected, the ease of immobilization, and the ease of handling, m is preferably an integer from 2 to 18, and more preferably an integer from 3 to 15. The methyl spacer refers to contiguous methylene groups connecting the cucurbituril moiety (cucurbituril structure) and an inorganic substance such as a metal.

In formula (1), X and Y each independently represent a chalcogen atom selected from the group consisting of oxygen, sulfur and selenium. Although there are a plurality of X's in formula (1), all the X's do not have to be the same kind of chalcogen atom and may be different from each other. From the viewpoint of ease of synthesis, as X, a sulfur atom and an oxygen atom are preferred, and an oxygen atom is most preferred.

Further, Y may be the same as or different from X, and Y is preferably a sulfur atom or an oxygen atom, and most preferably an oxygen atom.

R is a terminal functional group of the methylene spacer. R is preferably a substituent selected from the group consisting of SH, COOH, Si(OR₁)₃, PO(OH)₂ and SS-R₂. By bonding the S-atom, O-atom, Si-atom or P-atom contained in R to the surface of the inorganic substance, the compound of formula (1) is immobilized on the surface of the inorganic substance in the same orientation.

Among the above, R₁ of Si(OR₁)₃ is an alkyl moiety of an alkoxy group, preferably having 1 to 5 carbon atoms, and more preferably 1 to 2 carbon atoms.

Further, R₂ of SS-R₂ is not particularly limited as long as it is an organic group. Specific examples of R² may be alkyl, alkenyl, and cucurbituril. In a case where R₂ is SS-R₂, when the compound is to be immobilized on the surface of the inorganic substance, the S-S bond is broken, and the sulfur atom of the cucurbituril structure-containing compound the is bonded to the surface of the inorganic substance. The compound containing the broken out -S-R₂ can also be immobilized on the surface of the inorganic substance, and in consideration of this point, R₂ preferably contains a cucurbituril structure.

The compound of formula (1) can preferably be a compound represented by formulae (2) to (6) below.

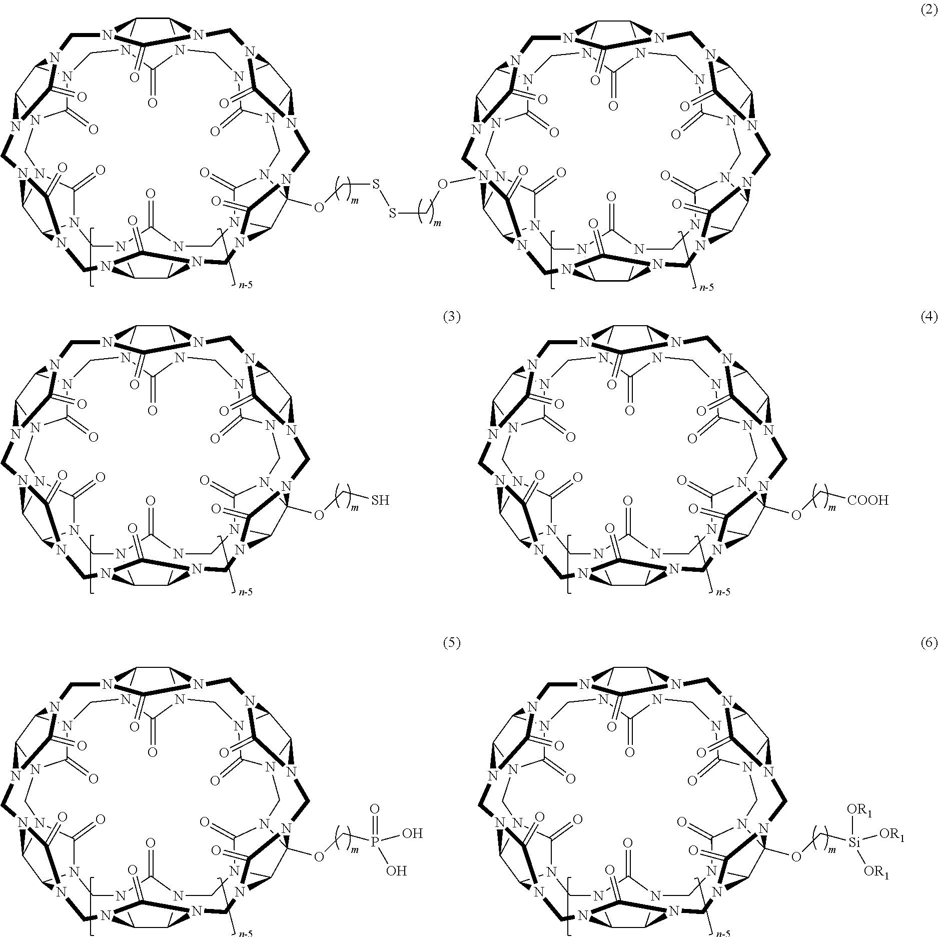

In formulae (2) to (6), n and m are the same as those in the formula (1). Further, R₁ in the formula (6) represents an alkyl group having 1 to 5 carbon atoms. When there are plural m's or R₁'s in each formula, the m's or R₁'s may be the same or different from each other.

One of the characteristics of the compound of the formula (1) is that it can interact with an inorganic substance such as a metal to form a self-assembled monolayer. Since the cucurbituril structure is expected to function as a host molecule, it is considered that the cucurbituril moiety separated from the inorganic substance by a methyl spacer can exert a new function.

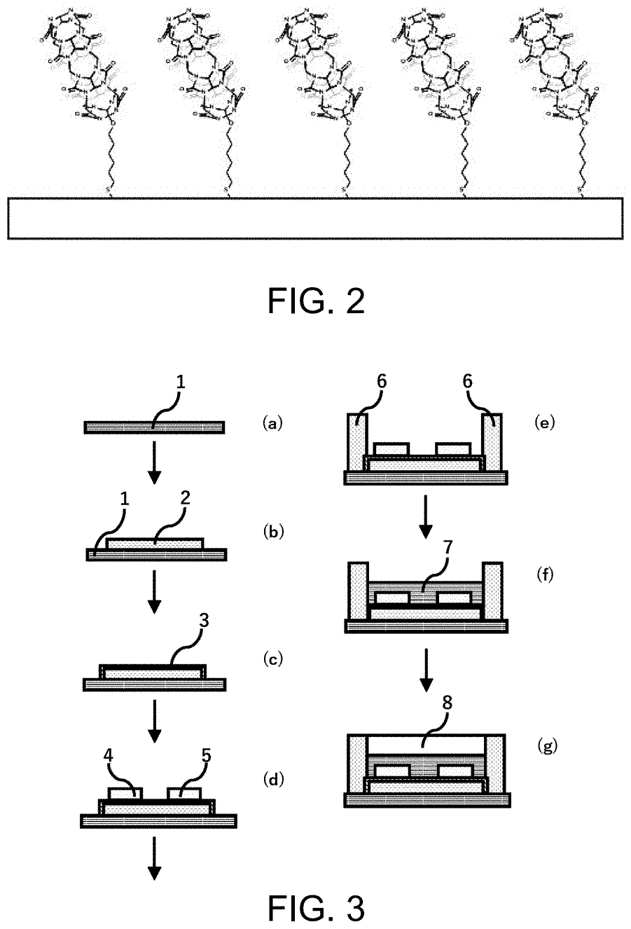

In the immobilization, as shown in FIG. 2, the compound of formula (1) is arranged on the surface of the electrode. For example, the compound of formula (1) is used on the surface of the electrode body to self-assemble. By performing the monolayer treatment (SAM treatment), the compound of formula (1) can be immobilized on the electrode metal surface.

(Transistor)

The sensor of this invention includes a transistor. As the transistor, an organic transistor or an inorganic transistor can be used, but a field effect transistor (particularly, a thin film transistor) is preferred because it is small and can be easily used.

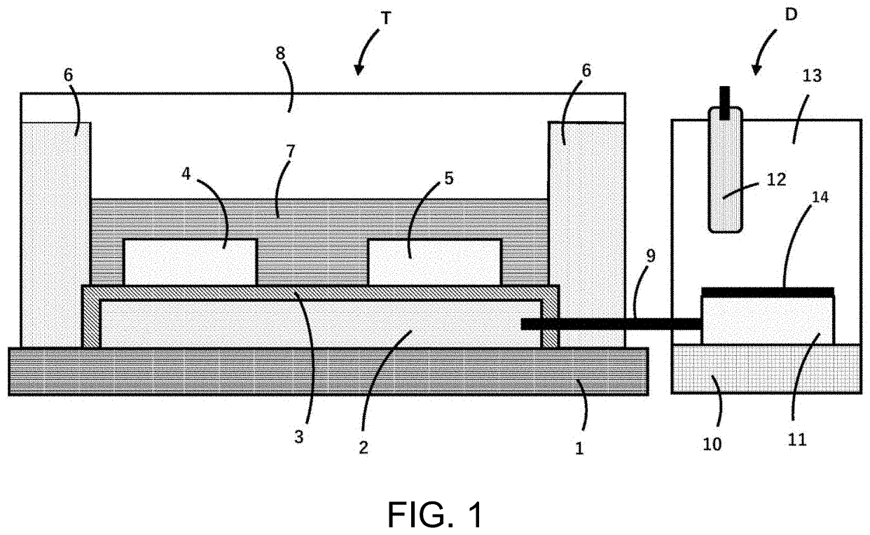

In this invention, as the field effect transistor, a field effect transistor having an ordinary configuration can be used, and an example is shown in FIG. 1. The field effect transistor T in FIG. 1 is a typical field effect transistor, including a substrate 1, a gate electrode 2, a gate insulating film 3, a source electrode 4, a drain electrode 5, a bank 6, an organic semiconductor (OSC) 7, and an encapsulating film 8.

The materials constituting the field effect transistor T are not particularly limited. For example, in addition to inorganic materials such as glass, ceramics and metal, organic materials such as resin and paper can be applied to the substrate 1. As the gate electrode 2, aluminum, silver, gold, copper, titanium, indium tin oxide (ITO), poly(3,4-ethylenedioxythiophene), polystyrene sulfonate or the like can be used. Examples of the material of the source electrode 4 and the drain electrode 5 include gold, silver, copper, platinum, aluminum, and conductive polymers such as PEDOT:PSS. Examples of the constituent material of the gate insulating film 3 include silica (silicon oxide), alumina (aluminum oxide), self-assembled monolayer, polystyrene, polyvinylphenol, polyvinyl alcohol, polymethylmethacrylate, polydimethylsiloxane, polysilsesquioxane, ionic liquid, and polytetrafluoroethylene, etc. Examples of the constituent material of the bank 6 include polytetrafluoroethylene. Examples of the constituent material of the encapsulating film 8 include polytetrafluoroethylene and polyparaxylylene.

The material of the organic semiconductor 7 is not particularly limited as long as its function can be exhibited, but in the case of P-type, pentacene, dinaphthothienothiophene, benzothienobenzothiophene (Cn-BTBT), TIPS pentacene, TES-ADT, rubrene, P3HT, PBTTT and so on can be used, and in the case of N-type, fullerene and so on can be used. Among them, the compound shown below and so on are preferably used, and they were also used as the semiconductor materials of the Examples described in the present specification.

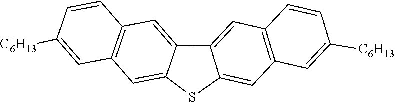

In addition, in FIG. 1, the detection electrode D includes a conductive wire 9, a detection electrode substrate 10, a detection electrode body 11, a reference electrode 12, and a self-assembled monolayer 14. The detection electrode body 11 is electrically connected to the gate electrode 2 of the transistor T by the conducting wire 9. In experiments, it is preferred to incorporate the detection electrode D in a tube in order to facilitate detection of a liquid.

Examples of the material of the detection electrode substrate 10 include polyethylene naphthalate and so on. The detection electrode body (extension gate electrode body) 11 is arranged on the surface of the detection electrode substrate 10. As the material of the detection electrode body 11, aluminum, silver, gold, copper, titanium, indium tin oxide (ITO), poly(3,4-ethylenedioxythiophene), polystyrene sulfonate and so on can be used as in the case of the gate electrode 2. As the reference electrode 12, a generally available reference electrode may be used, and examples thereof include Ag/AgCl.

In addition, a self-assembled monolayer 14 is formed on the detection electrode body 11, including a cucurbituril structure-containing compound. It is preferred that the cucurbituril structure-containing compound is in the state of a self-assembled monolayer in consideration of which state of the cucurbituril structure-containing compound being arranged on the extension gate electrode body 11 allows a detection function to be exhibited.

The transistor-type sensor of this invention is able to detect a compound having an amino group by measuring a change in the threshold voltage or drain current value caused by binding of the compound having an amino group to a cucurbituril structure-containing compound immobilized on the detection electrode. That is, the transistor-type sensor according to this invention is a device that performs detection based on the binding between a cucurbituril structure-containing compound immobilized on an extension gate of a transistor and the compound having an amino group. With such a sensor, it is possible to monitor the substance to be detected (compound having an amino group) stably and easily based on changes of the characteristics of the transistor.

[Manufacturing Method of Transistor-type Sensor]

### (Manufacturing of Detection Electrode)

The fabrication of the detection electrode includes a step of immobilizing a cucurbituril structure-containing compound on the surface of an inorganic substance such as a metal. The method for immobilizing the cucurbituril structure-containing compound is not particularly limited, and various methods such as spin coating and dip coating can be used.

As a simple method, the detection electrode can be obtained by immersing, overnight in a mixed solution obtained by mixing a cucurbituril structure-containing compound in a solvent, an inorganic substance constituting the electrode, such as gold, and performing drying if necessary. The concentration of the cucurbituril structure-containing compound in the mixed solution is not particularly limited, but can be, for example, from 0.01 mM to 1 M. Although FIG. 3 shows an example using the reference electrode 12, it may or may not be used.

(Fabrication of Transistor)

Fabrication of the transistor is not particularly limited, but may be based on a dry process such as an evaporation method or a sputtering method, etc., a coating process by spin coating, bar coating or spray coating, etc., or a printing process using any of various printing machines such as those for screen printing, gravure offset printing, letterpress reversal printing, and inkjet printing, etc. If printing is utilized, the fabrication can be more efficient and cost less.

An exemplary method for fabricating the transistor T shown in FIG. 1 will be described with reference to FIG. 3. First, a substrate 1 (the material is glass) is prepared (a), and a gate electrode 2 (the material is aluminum) having a thickness of 30 nm is formed on the substrate 1 (b). Then, a RIE treatment (forming an aluminum oxide film by reactive ion etching treatment) is performed for 15 minutes, and the gate insulating film 3 is formed with a HFPA treatment (c). Further, source/drain electrodes 4 and 5 (each material is gold) are formed through patterning (d). After that, a bank 6 (the material is polytetrafluoroethylene) is formed (e), and the layer of the organic semiconductor 7 is formed (f). Finally, an encapsulating film 8 (the material is polytetrafluoroethylene) is formed by spin coating or the like (g) to produce a transistor T.

A transistor-type sensor can be fabricated by connecting the gate electrode 2 and the detection electrode D.

[Detection Method and Substances to be Detected]

By bringing a solution or gas containing a compound having an amino group into contact with the detection electrode, the shift amount of the threshold voltage is increased, and detection is carried out by measuring the shift amount.

The temperature during the detection is not particularly limited, but the detection can be performed at room temperature. Further, the pressure during the detection is not particularly limited, but the detection can be performed in the atmosphere. Therefore, the transistor-type sensor can be expected to be used as a simple and portable sensor.

The pH during the detection is not particularly limited, and the detection can be made at any of acidic, neutral and basic pH. Depending on the substance to be detected, the detection intensity may change due to difference in pH. If such characteristic is present, it may be easier to identify the substance to be detected by performing measurements at different pH values.

The substance to be detected is a compound having an amino group. The compound having an amino group is not particularly limited as long as it has an amino group therein, and may be an amine compound, a polyamine, an amino acid or a protein, etc. It is considered that the compound can be detected by some interaction between the compound having an amino group and the cucurbituril structure-containing compound.

Examples of compounds having an amino group include, for example, a compound having an amino group having a molecular weight of 10,000 or less, a compound having an amino group having a molecular weight of 5,000 or less, a compound having an amino group having a molecular weight of 2,000 or less, and a compound having an amino group having a molecular weight of 1,000 or less. If the molecular weight is 10,000 or less, a signal that can be sufficiently detected may be obtained, so the range is preferred.

The to-be-detected substance of the transistor-type sensor of this invention may be a compound having polarity and being soluble in water., such as a compound having a solubility in water of 10 mg or more with respect to 100 g of water. The solubility in water is preferably 50 mg or more or 100 mg or more.

The number of the amino groups contained in the compound may possibly be 1 or more, 2 or more, 3 or more, or 4 or more, etc.

Examples of the amine compound include aliphatic amines, aromatic amines, amino alcohols, imidazoles, benzotriazoles, guanidines, hydrazides and amino acids, etc., and also derivatives thereof and the like. In addition, polyamines, proteins and so on are also included.

Examples of the aliphatic amines include dimethylamine, ethylamine, 1-aminopropane, isopropylamine, trimethylamine, allylamine, n-butylamine, diethylamine, sec-butylamine, tent-butylamine, N,N-dimethylethylamine, isobutylamine and cyclohexyl.

Examples of the aromatic amines include aniline, N-methylaniline, diphenylamine, N-isopropylaniline, p-isopropylaniline and so on.

Examples of the amino alcohols include 2-aminoethanol, 2-(ethylamino)ethanol, diethanolamine, diisopropanolamine, triethanolamine, N-butyldiethanolamine, triisopropanolamine, N,N-bis(2-hydroxyethyl)-N-cyclohexylamine, N,N,N′N′-tetraki s(2-hydroxypropyl)ethylenediamine, and N,N,N,N″,N″-pentakis(2-hydroxypropyl)diethylenetriamine, etc.

Examples of the imidazole include 2-methylimidazole, 2-undecylimidazole, 2-heptadecylimidazole, 1,2-dimethylimidazole, 2-ethyl-4-methylimidazole, 2-phenylimidazole, 2-phenyl-4-methylimidazole, 1 -benzyl-2-methylimidazole, 1-benzyl-2-phenylimidazole, 1-cyanoethyl-2-methylimidazole, 1-cyanoethyl-2-undecylimidazole, 1-cyanoethyl-2-ethyl-4-methylimidazole, 1-cyanoethyl-2-phenylimidazole, 1-cyanoethyl-2-undecylimidazolium trimellitate, 1-cyanoethyl-2-phenylimidazolium trimellitate, 2,4-diamino-6-[2′&#8212;methylimidazolyl-(1)]&#8212;ethyl-s-triazine, 2,4-diamino-6-[2′&#8212;undecylimidazolyl-(1)]&#8212;ethyl-s-triazine, 2,4-diamino-6-[2′&#8212;ethyl-4′&#8212;methylimidazolyl-(1)]&#8212;ethyl-s-triazine, isocyanuric acid adduct of 2,4-diamino-6-[2′&#8212;methylimidazolyl-(1)]&#8212;ethyl-s-triazine, isocyanuric acid adduct of 2-phenylimidazole, 2-phenyl-4, 5 -dihydroxymethylimidazole, 2-phenyl-4-methyl-5-hydroxymethylimidazole, 2,3 -dihydro-1H-pyrrolo[1,2-a]b enzimidazole, 1-dodecyl-2-methyl-3-benzylimidazolium chloride, 2-methylimidazoline, 2-phenylimidazolin, 2,4-diamino-6-vinyl-s-triazine, isocyanuric acid adduct of 2,4-diamino-6-vinyl-s-triazine, 2,4-diamino-6-methacryloyloxyethyl-s-triazine, epoxy&#8212;imidazole adduct, 2-methylbenzoimidazole, 2-octylbenzoimidazole, 2-pentylbenzoimidazole, 2-(1-ethylpentyl)benzoimidazole, 2-nonylbenzoimidazole, 2-(4-thiazolyl)benzoimidazole, and benzoimidazole, etc.

Further examples are imidazole dipeptides, including carnosine, anserine, balenine and homocarnosine.

In addition, the imidazoles also contain compounds having a cyclic structure using the carbon of imidazole. Such compounds include, for example, adenine-containing compounds.

An adenine-containing compound means a compound containing adenine in its structure. The adenine-containing compounds include compounds having a nucleotide structure, and examples of the compounds having a nucleotide structure include inosinic acid, guanylic acid, and nicotinamide adenine dinucleotide (NAD⁺), etc.

Examples of the benzotriazoles include
2-(2′&#8212;hydroxy-5′&#8212;methylphenyl)benzotriazole,
2-(2′&#8212;hydroxy-3′&#8212;tert-butyl-5′&#8212;methylphenyl)-5-chlorobenzotriazole,
2-(2′&#8212;hydroxy-3′, 5′&#8212;di-tent-amylphenyl)benzotriazole,
2-(2′&#8212;hydroxy-5′-tent-octylphenyl)benzotriazole,
2,2′&#8212;methylenebis[6-(2H-benzotriazole-2-yl)-4-tert-octylphenol],
6-(2-benzotriazolyl)-4-tert-octyl-6′-tert-butyl-4′-methyl-2,2′-methylenebisphenol,
1,2,3-benzotriazole, 1-[N,N-bis(2-ethylhexyl)aminomethyl]benzotriazole, carboxybenzotriazole,

1-[N,N-bis(2-ethylhexyl)aminomethyl]methylbenzotriazole,
2,2′&#8212;[[(methyl-1H-benzotriazole-1-yl)methyl]imino]bisethanol, aqueous solution of sodium salt of 1,2,3-benzotriazole, 1-(1′,2′&#8212;dicarboxyethyl)benzotriazole,
1-(2,3-dicarboxypropyl)benzotriazole, 1-[(2-ethylhexylamino)methyl]benzotriazole,
2,6-bis[(1H-benzotriazole-1-yl)methyl]-4-methylphenol, and 5-methylbenzotriazole, etc.

Examples of the guanidines include carbodihydrazide, malonic acid dihydrazide, succinic acid dihydrazide, adipic acid dihydrazide,
1,3-bis(hydrazinocarbonoethyl)-5-isopropylhydantoin, sebacic acid dihydrazide, dodecanedioic acid dihydrazide, 7,11-octadecadiene-1,18-dicarbohydrazide, and isophthalic acid dihydrazide, etc. Examples of the hydrazide include dicyandiamide, 1,3-diphenylguanidine, and
1,3-di-o-tolylguanidine, etc.

Examples of the amino acids include alanine, arginine, asparagine, aspartic acid, cysteine hydrochloride, glutamine, glutamic acid, glycine, histidine, isoleucine, leucine, lysine monohydrochloride, methionine, phenylalanine, proline, serine, threonine, tryptophan, tyrosine, valine, β-alanine, γ-aminobutyric acid, δ-aminovaleric acid, ε-aminohexanoic acid, εrolactam, and 7-aminoheptanoic acid, etc.

Examples of the polyamines include: diamines such as ethylenediamine, propylenediamine, diaminobutane, diaminopentane, diaminohexane, diaminoheptane, diaminooctane, diaminodecane and diaminododecane, etc.; and trivalent or higher amines such as diethylenetriamine and triethylenetetramine, etc. Further examples include putrescine, cadaverine, spermidine and spermine, etc.

Amino acid polymers, namely proteins are also substances to be detected by the transistor-type sensor of this invention. Examples of the proteins include collagen, keratin, albumin, apolipoprotein, ferritin, hemosiderin, actin, myosin, and globulin.

### EXAMPLES

Hereinafter, this invention will be described in more details based on Examples, but this invention is not limited to these Examples.

### Synthesis Example 1

Synthesis of cucurbit[6]uril (hereinafter referred to as CB[6]) dimer

### (First step) Synthesis of bisimidazolinium salt-encapsulating CB [6]-monohydroxy compound

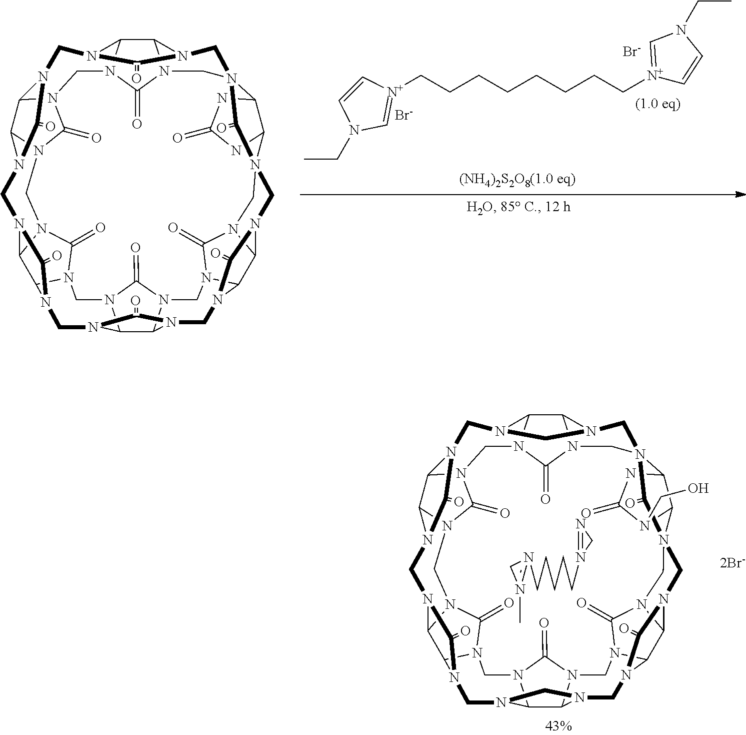

The synthesis was according to the references “Zhao, N.; Lloyd, G. O.; Scherman, O. A. Chem. Commun., 2012, 48 (25), 3070-3072, as described below.

In the atmosphere, a reflux condenser was attached to a 100 mL two-necked eggplant flask, CB[6] (0.5 g, 0.5 mmol), 3,3′-(octane-1,8-diyl)bis(1-ethylmidazolinium) bromide (232 mg, 0.5 mmol) and water (50 mL) were added, the temperature was raised to 85° C., and the mixture was stirred for 1 hour. After confirming a certain extent of dissolution, (NH₄)₂S₂O₈ (114 mg, 0.5 mmol) was added thereto. After stirring for 12 hours, the temperature was returned to room temperature, and water was distilled off utilizing a rotary evaporator. The obtained solid was fractioned using reverse phase column chromatography (the resin was CHP 20P produced by Mitsubishi Chemical Corporation) with water as an eluent. Every 10 mL of the elute was taken as a fraction, the fractions in which the target product was present was selected by LC/MS, and the solvent was removed by a rotary evaporator to obtain the target white solid (collected amount: 320 mg; yield: 43%).

### (Second step) Synthesis of 6,6′-disulfanediylbis(hexane-1-ol)

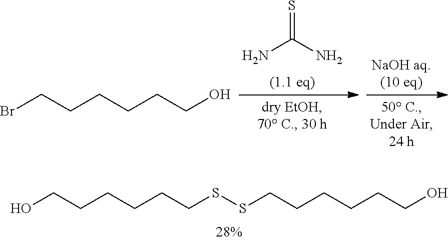

A reflux condenser and a dropping funnel were attached to a 100 mL three-necked eggplant flask, dry ethanol (25 mL), thiourea (1.25 g, 16.5 mmol) and 6-bromohexane-1-ol (2.71 g, 16.5 mmol) were added, the temperature was raised to 70° C., and the mixture was stirred for 30 hours. Then, the temperature was lowered to 50° C., an aqueous solution of NaOH (6 g, 150 mmol) (18 mL) was added dropwise, and the mixture was exposed to the atmosphere and stirred for another day. After returning to room temperature, the obtained brown solution was subject to a liquid separation operation with chloroform (45 mL) and water (45 mL), and the aqueous layer was extracted with chloroform. The combined organic layer was washed 3 times with water (45 mL), dried over sodium sulfate and filtered, and the organic solvent of the filtrate was removed by a rotary evaporator to obtain a brown oil (collected amount: 1.11 g; yield: 28%).

¹H NMR (400 MHz, CDCl₃): δ 1.24&#8211;1.71 (m, 16H, (CH₂)₄) 2.68 (t, J=5.0 Hz, 4H, CH₂), 3.65 (t, J=9.3 Hz, 4H, CH₂).

### (Third step) Synthesis of 1,2′-bis(6-bromohexyl)disulfane

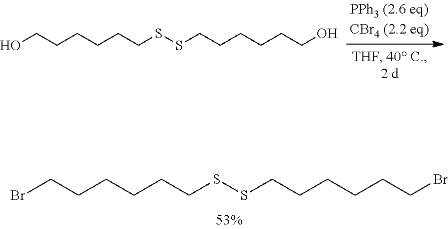 [SMILES: OCCCCCCSSCCCCCCO ; BrCCCCCCSSCCCCCCBr]

A reflux condenser and a dropping funnel were attached to a 50 mL three-necked flask, and a tetrahydrofuran solution of 6,6′-disulfanediylbis(hexane-1-ol) (1.10 g, 4.13 mmol) (6 mL) was added to a tetrahydrofuran solution of carbon tetrabromide (3.01 g, 9.08 mmol) (6 mL). After stirring for 10 minutes, a tetrahydrofuran solution of triphenylphosphine (2.81 g, 10.73 mmol) (10 mL) was added dropwise, and the temperature was raised to 40° C. At this time, it was confirmed that the color of the solution changed from orange to dark green, and finally it became a suspension. After stirring for 2 days, the suspension was subject to a liquid separation operation by adding chloroform (30 mL) and water (30 mL), the aqueous layer was extracted twice with chloroform (20 mL), and the organic layer was washed twice with water (20 mL) and dried with sodium sulfate. After the desiccant was filtered off, a crude product (5.21 g) was obtained by removing the organic solvent with a rotary evaporator and then purified by silica gel column chromatography using chloroform:hexane=1:4 as an eluent. The silica gel used was 40 g. The solvent was removed to obtain a yellowish oil (collected amount: 862 mg; yield: 53%) as the target compound.

R_{f}=0.39. ¹H NMR (400 MHz, CDCl₃): δ 1.25&#8211;1.44 (m, 8H, (CH₂)₄) 1.69 (quint, J=8.0 Hz, 4H, CH2) 1.88 (quint, J=5.8 Hz, 4H, CH2), 2.69 (t, J=5.8 Hz, 4H, CH&shy;2), 3.41 (t, J=5.8 Hz, 4H, CH₂).

### (4th step) Synthesis of CB[6] dimer

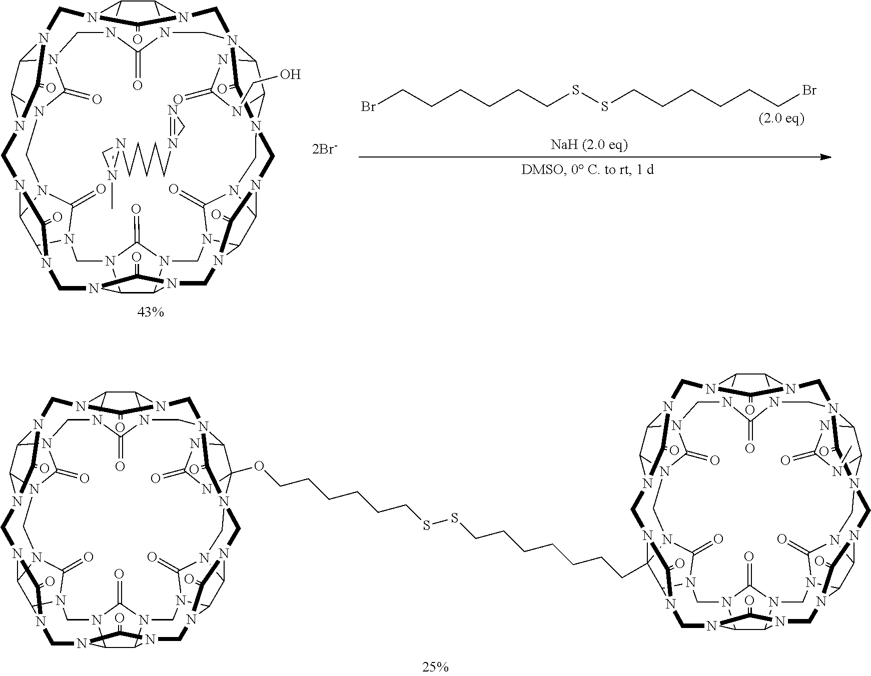

The bisimidazolinium salt-encapsulating CB[6]-monohydroxy compound (100 mg, 0.07 mmol) obtained in the first step was dissolved in dimethyl sulfoxide (7 mL) in a 30 mL two-necked flask under a nitrogen atmosphere. After stirring for 10 minutes, sodium hydride (5.42 mg, 0.14 mmol, content in oil: 60%) was added, and the mixture was cooled to 0° C. After stirring for 15 minutes, 1,2′-bis(6-bromohexyl)disulfane (53.11 mg, 0.14 mmol) was added, and the temperature was returned to room temperature. After stirring for 1 day, the obtained white-orange suspension was allowed to stand for 1 day to separate a precipitate, and was filtered to obtain a white solid target product (collected amount: 39 mg; yield: 25%).

### Electrode Fabrication Example 1

### Fabrication of Self-Assembled Monolayer Electrode (SAM-Treated Electrode)

The polyethylene naphthalate substrate was covered with a mask, and 100 nm of gold was deposited by evaporation. The substrate was then cut into an appropriate size, and a UV-ozone treatment was performed for 10 minutes. The treated substrate was immersed in a methanol solution (0.3 mM) of the CB[6] dimer synthesized in Synthesis Example 1 overnight to obtain a self-assembled monolayer electrode (SAM-treated electrode). The substrate not treated with the methanol solution of the CB [6] dimer was used as an untreated electrode.

### Example 1

Fabrication of Transistor-Type Sensor using SAM-Treated Electrode

A transistor-type sensor of this invention was fabricated by connecting the SAM-treated electrode obtained in Electrode Fabrication Example 1 as a detection electrode to the gate electrode of the transistor obtained using the fabrication method as shown in FIG. 3. In the transistor-type sensor of this embodiment, the gate terminal (not shown) of the semiconductor parameter analyzer was connected to the reference electrode (Ag/AgCl).

(Carnosine Detection Experiment)

The detection electrode provided in the transistor type sensor of Example 1 is arranged in the lower part of a glass tube, a 900 μL aqueous solution containing 10 mM of HEPES and 100 mM of NaCl was loaded in the tube as a buffer solution, the transistor is operated 5 times to stabilize the transistor-type sensor, and then measurement was performed three times under the same conditions.

A predetermined amount of the substance to be detected was gradually dropped, and after stand-by of 10 minutes, measurement was started for the evaluation. In the measurement, the source-drain voltage (Vps) was −1V, and the gate voltage (V_{G}) was 0.5 to 3V. The pH of the buffer solution was 7.4.

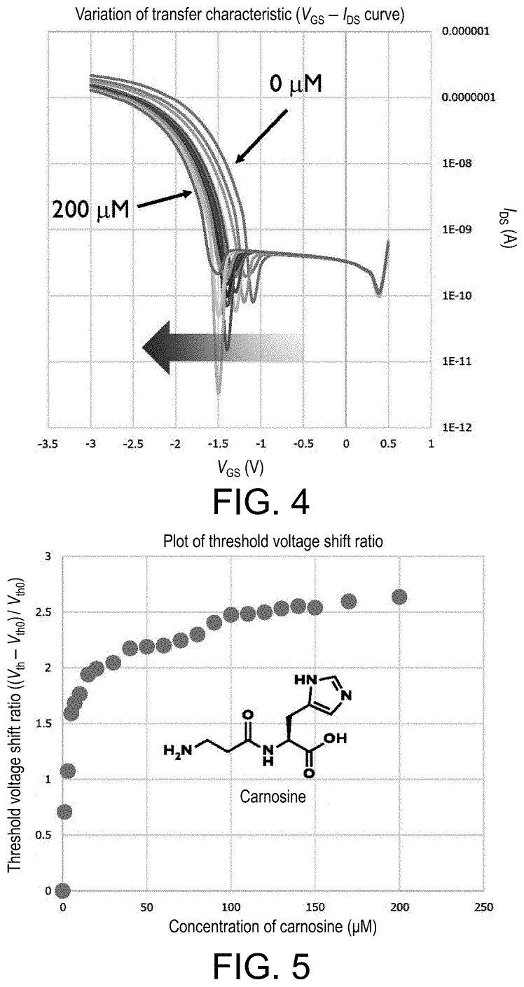

A carnosine solution having a concentration varying in the range of 0 μM to 200 μM was dropped to the glass tube provided with the detection electrode of the stabilized transistor-type sensor. The results are shown in FIGS. 4 and 5. In FIG. 4, it was found that VGS moves in the negative direction by increasing the concentration. Further, from FIG. 5, it was found that the threshold voltage shift ratio changed with respect to the solution containing no carnosine even if the concentration of carnosine was relatively low.

(Anserine Detection Experiment)

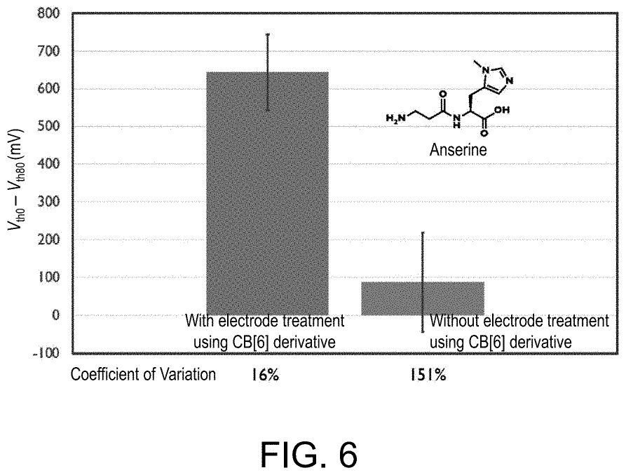

The same experimental equipment as in the carnosine detection experiment was used. About the substance to be detected, an anserine solution (1 mM) was added to a buffer solution of HEPES (10 mM) and NaCl (100 mM) so as to be 80 μM, and the experiment was performed three times. Here, Vₜₕ₀ is the threshold voltage when the substance to be detected was not contained, and Vₜₕ₈₀ was the threshold voltage when the concentration of the substance to be detected was 80 μM. The results are shown in FIG. 6. When the SAM-treated electrode was used, the threshold voltage shift amount was large, and the difference from the case where the detection substance was not contained was clear. It was confirmed that the threshold voltage shift ratio also varied for balenine. The pH of the buffer solution was 7.4.

(Amino Acid Detection Experiments, Under Neutral Condition)

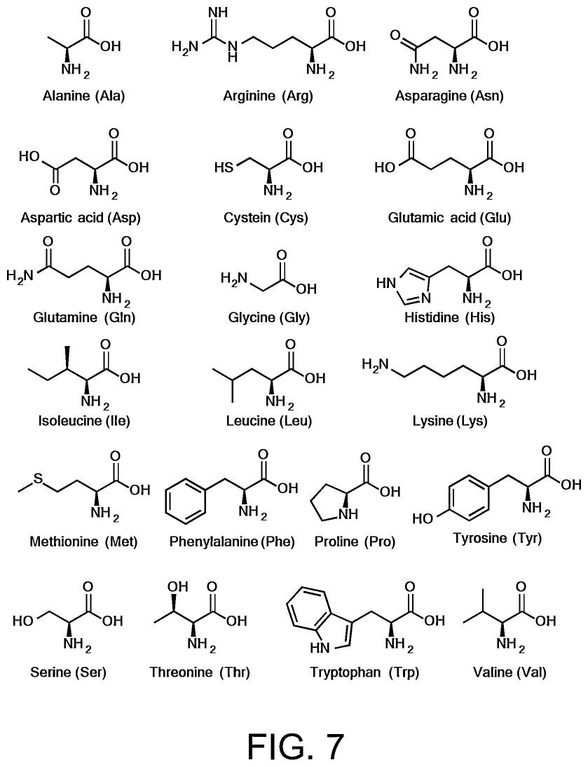

Detection experiments of 20 kinds of amino acids constituting various proteins (alanine, arginine, asparagine, aspartic acid, cysteine, glutamine, glutamine acid, glycine, histidine, isoleucine, leucine, lysine, methionine, phenylalanine, proline, serine, threonine, tryptophan, tyrosine and valine as shown in FIG. 7) as amino group-having compounds to be detected were performed under a neutral condition.

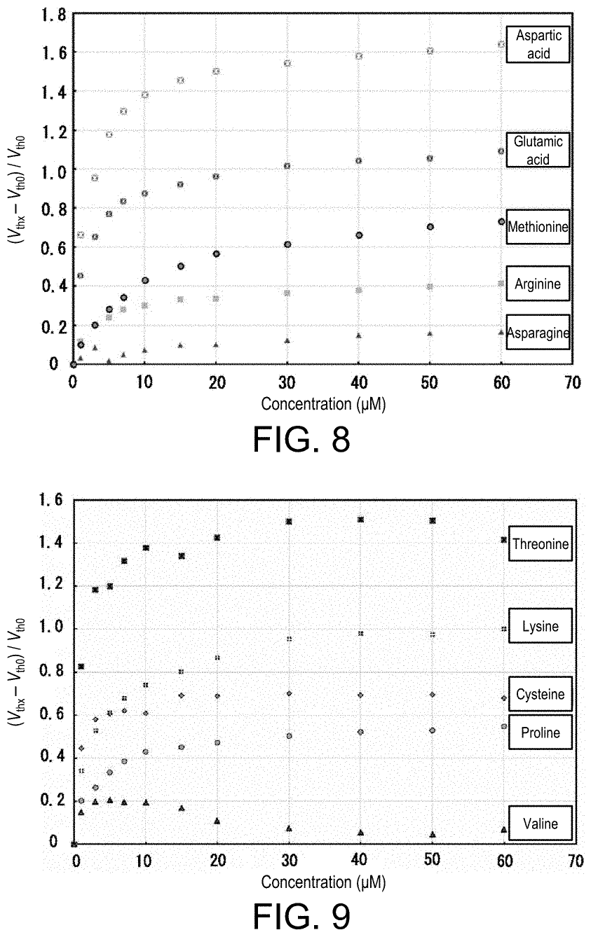

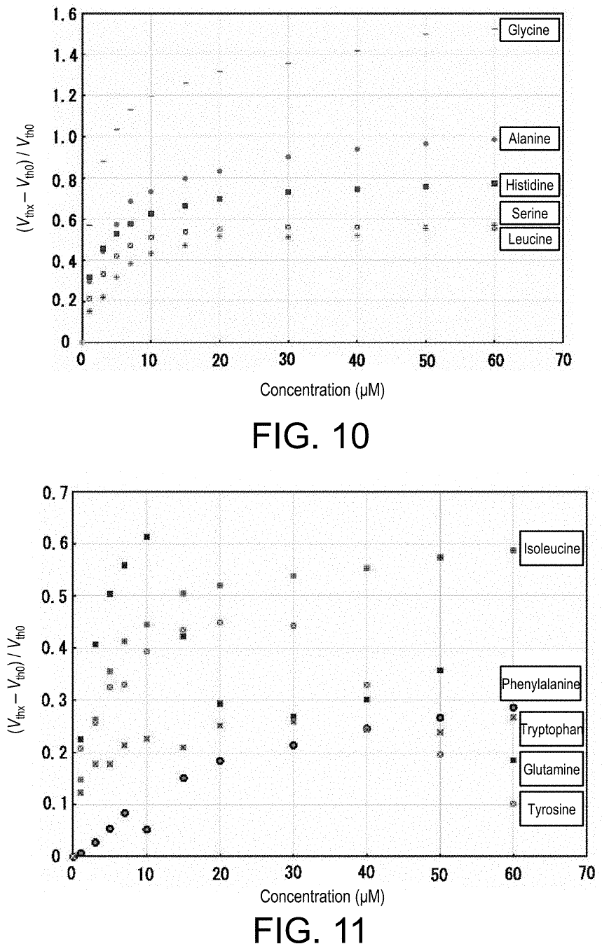

As the experimental device, the same device as used in the carnosine detection experiment was used. A 1 mM solution of the amino acid as a substance to be detected was gradually added to a 900 μL buffer solution of HEPES (10 mM) and NaCl (100 mM) with pH=7.4, in amounts of 0.9 μL, 1.8 μL, 1.8 μL, 1.8 μL, 2.7 μL, 4.5 μL, 4.5 μL, 9 μL, 9 μL, 9 μL and 9 μL. As a result, the detection concentration became 1 μM, 3 μM, 5 μM, 7 μM, 10 μM, 15 μM, 20 μM, 30 μM, 40 μM, 50 μM and 60 μM, respectively, and a titration plot was drawn. Here, Vₜh0 is the threshold voltage when the substance to be detected was not contained, and Vₜₕₓ is the threshold voltage when the concentration of the substance to be detected was x μM. The results are shown in FIGS. 8 to 11. The horizontal axis is the detection concentration and the vertical axis is the shift ratio of the threshold voltage, and it was confirmed that each amino acid could be detected in any of the experiments. In addition, it was confirmed that a difference in the shift ratio ((Vₜₕₓ-Vₜₕ₀)/Vₜₕ₀), namely a difference in detection intensity appeared depending on the kind of the amino acid.

(Amino Acid Detection Experiments, Under Acidic Conditions)

Detection experiments of 20 kinds of amino acids constituting various proteins (alanine, arginine, asparagine, aspartic acid, cysteine, glutamine, glutamine acid, glycine, histidine, isoleucine, leucine, lysine, methionine, phenylalanine, proline, serine, threonine, tryptophan, tyrosine and valine as shown in FIG. 7) as amino group-having compounds to be detected were performed under an acidic condition.

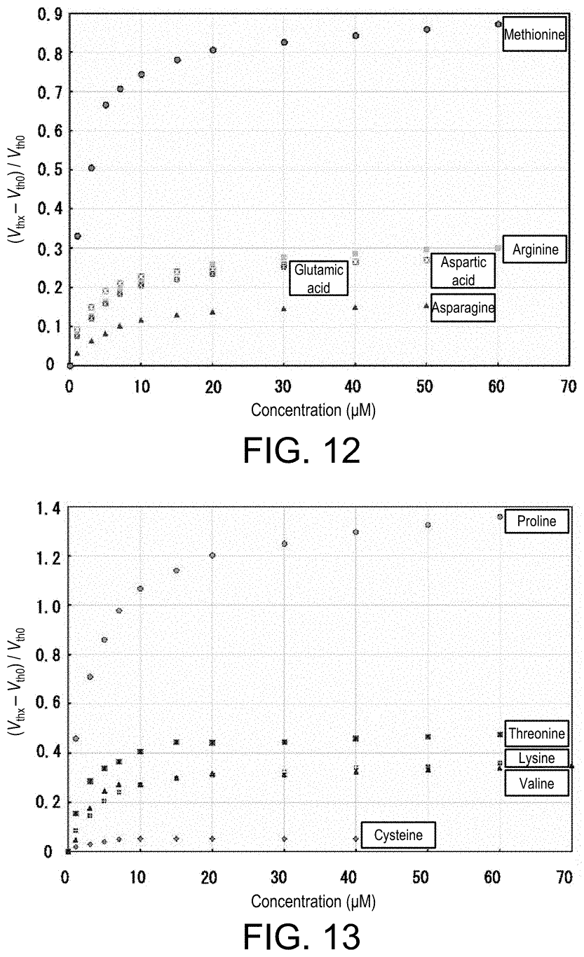

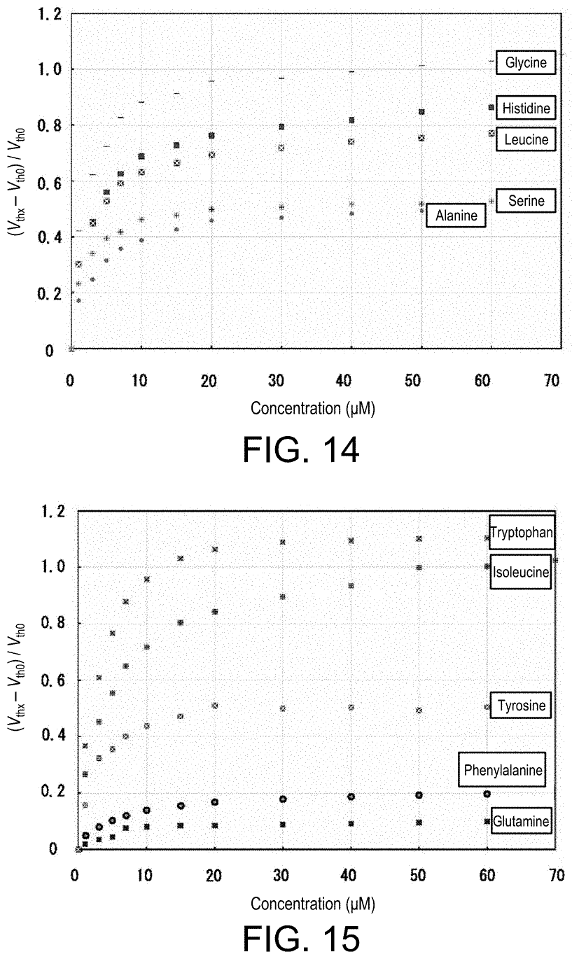

As the experimental device, the same device as used in the carnosine detection experiment was used. A 1 mM solution of the amino acid as the substance to be detected was gradually added to 900 μL of dilute hydrochloric acid with pH=3, in amounts of 0.9 μL, 1.8 μL, 1.8 μL, 1.8 μL, 2.7 μL, 4.5 μL, 4.5 μL, 9 μL, 9 μL, 9μL, and 9 μL. As a result, the detection concentration became 1 μM, 3 μM, 5 μM, 7 μM, 10 μM, 15 μM, 20 μM, 30 μM, 40μM, 50 μM and 60 μM, respectively, a titration plot was drawn. Here, Vₜho is the threshold voltage when the substance to be detected was not contained, and Vₜi is the threshold voltage when the concentration of the substance to be detected was x μM. The results are shown in FIGS. 12 to 15.

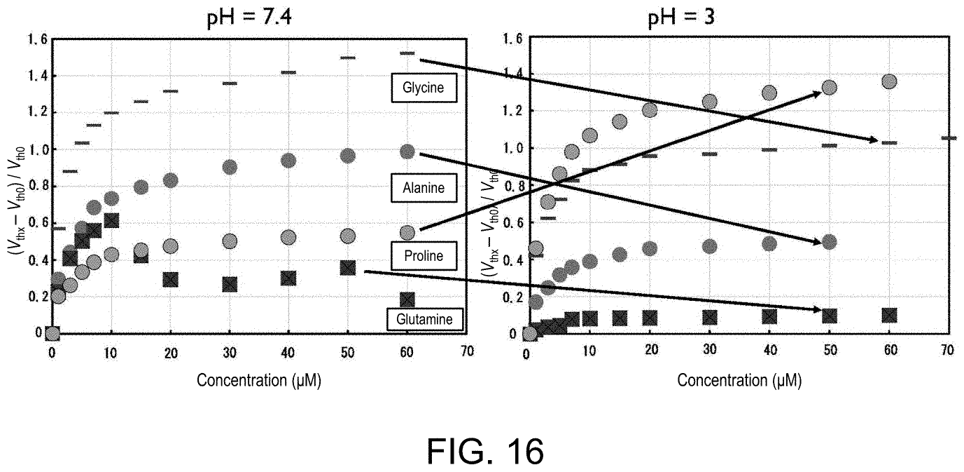

It was found that, as shown in FIG. 16, depending on the kind of the amino acid, the shift ratio, namely the detection intensity may be higher under an acidic condition than under a neutral condition as in the case of proline ((Vₜₕₓ-Vₜₕ₀)/Vₜₕ₀=0.6 under the neutral condition; (Vₜₕₓ-Vₜₕ₀)/Vₜho=1.4 under the acidic condition), or conversely be lower as in the case of alanine ((Vₜₕₓ-Vₜₕ₀)/Vₜₕ₀=1.0 under the neutral conditions; (Vₜₕₓ-Vₜₕ₀)/Vₜₕ₀=0.5 under the acidic condition). It is expected that it will be possible to discriminate chemical species in the future by cross-utilizing the difference in the detection intensity of each amino acid in response to such a measurement environment.

### Synthesis Example 2

Synthesis of cucurbit[7]uril (hereinafter referred to as CB[7]) dimer

A CB [7] dimer was obtained with the same method according to Steps 1 to 4 of Synthesis Example 1 except that CB[7] was used instead of CB[6] that was used in Synthesis Example 1.

### Electrode Fabrication Example 2

### Fabrication of Self-Assembled Monolayer Electrode (SAM-Treated Electrode)

A self-assembled monolayer electrode (SAM-treated electrode) was obtained in the same manner as in Electrode Fabrication Example 1 except that CB [7] was used instead of CB [6] that was used in Electrode Fabrication Example 1.

### Example 2

Fabrication of Transistor-Type Sensors using SAM-Treated Electrode

A transistor-type sensor of this invention was fabricated with the same fabrication method as in Example 1 using the SAM-treated electrode obtained in Electrode Fabrication Example 2 as the detection electrode. In the transistor-type sensor of this embodiment, the gate terminal of the semiconductor parameter analyzer was connected to the reference electrode (Ag/AgCl).

(Detection experiments of inosinic acid, guanylic acid, and nicotinamide adenine dinucleotide (NAD⁺))

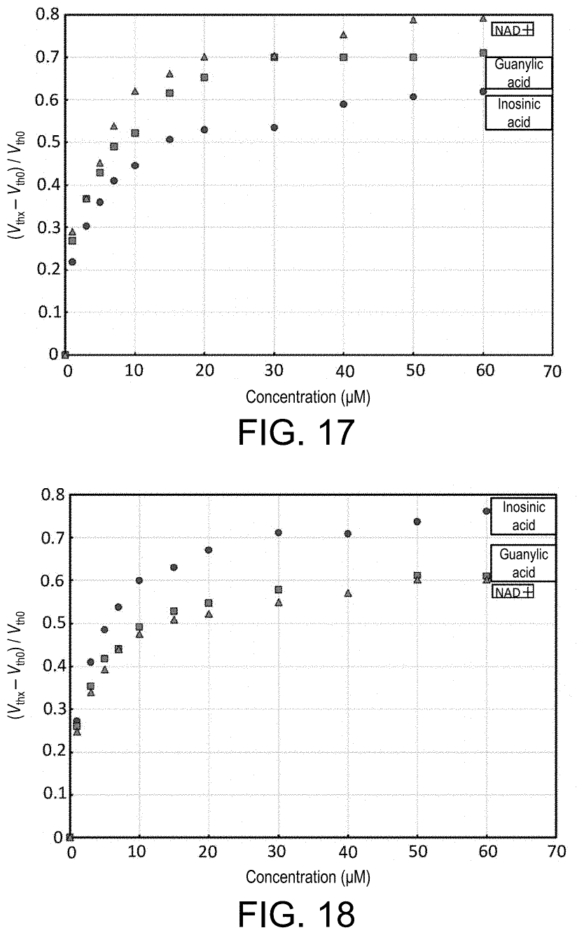

Inosinic acid, guanylic acid, and nicotinamide adenine dinucleotide were detected using the same experiment apparatus as used in the carnosine detection experiment. The detection was carried out using the sensor of Example 1 and the sensor of Example 2. About the detection substance, a solution (1 mM) of each of inosinic acid, guanylic acid, and nicotinamide adenine dinucleotide was added to a buffer solution of HEPES (10 mM) and NaCl (100 mM) so as to make a concentration of 80 μM, and the experiment was performed three times for each of them. Here, Vₜₕ₀ is the threshold voltage when the substance to be detected was not contained, and Vₜₕ₈₀ is the threshold voltage when the concentration of the substance detection was 80 μM. The results are shown in FIGS. 17 and 18. It was confirmed that the threshold voltage shift ratio changed in both the sensor of Example 1 (FIG. 17) and the sensor of Example 2 (FIG. 18). The pH of the buffer solution was 7.4 in both the apparatus of Example 1 and the apparatus of Example 2.

Inosinic acid, guanylic acid, and nicotinamide adenine dinucleotide inosinic acid are all umami ingredients, and it is suggested that identification and quantification of the umami ingredients in foods can be made.

### INDUSTRIAL APPLICABILITY

The transistor-type sensor of this invention is capable of detecting a compound having an amino group and is also very simple as an apparatus, thus having industrial applicability.

### REFERENCE SIGNS LIST

T: field effect transistor

D: detection electrode

1: substrate

2: gate electrode

3: gate insulating film

4: source electrode

5: drain electrode

6: bank

7: organic semiconductor

8: encapsulating film

9: conductive wire

10: detection electrode substrate

11: detection electrode (extension gate)

12: reference electrode

13: tube

14: self-assembled monolayer

1. A transistor-type sensor, comprising:
a detection electrode for capturing a compound having an amino group for detection; and
a transistor having a gate electrode connected with the detection electrode,
wherein the detection electrode has a cucurbituril structure-containing compound immobilized on a surface thereof

2. The transistor-type sensor of claim 1, wherein the compound having an amino group has a molecular weight of 10,000 or less.

3. The transistor-type sensor of claim 1, wherein the compound having an amino group is selected from the group consisting of polyamines, amino acids, and peptide bonding-containing compounds.

4. The transistor-type sensor of claim 1, wherein the compound having an amino group is an imidazole dipeptide.

5. The transistor-type sensor of claim 1, wherein a threshold voltage or a drain current of the transistor changes on capturing the compound having an amino group.

6. The transistor-type sensor of claim 1, wherein the cucurbituril structure-containing compound interacts with the surface of the detection electrode to form a self-assembled monolayer.

7. The transistor-type sensor of claim 1, wherein the cucurbituril structure-containing compound is a compound represented by formula (1), 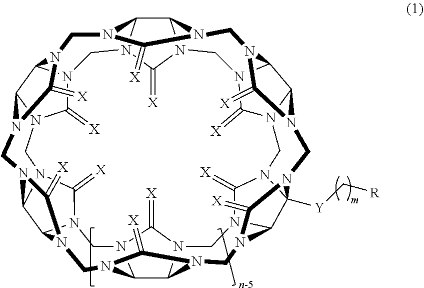
wherein n is an integer from 5 to 20, m is an integer from 1 to 10, X and Y each independently represent a chalcogen atom selected from the group consisting of oxygen, sulfur and selenium, R represents a substituent selected from the group consisting of SH, COOH, Si(OR₁)₃, PO(OH)₂ and SS-R₂, R₁ represents an alkyl group having 1 to 5 carbon atoms, and R₂ represents an organic group.
